(19) United States
(12) Patent Application Publication
(10) Pub. No.: US 2006/0131538 A1
(43) Pub. Date: Jun. 22, 2006

(54) Hydrogen generating compositions and associated uses and methods of manufacture

(76) Inventor: Bart A. Siegel, Greenback, TN (US)

Correspondence Address: GREENBERG TRAURIG LLP, 2450 COLORADO AVENUE, SUITE 400E, SANTA MONICA, CA, 90404, US

(21) Appl. No.: 11/267,084

(22) Filed: Nov. 3, 2005

Related U.S. Application Data
(60) Provisional application No. 60/625,018, filed on Nov. 3, 2004.

(51) Int. Cl. C22C 18/00; H01J 7/18

(52) U.S. Cl. 252/181.1; 420/513; 423/648.1

(57) ABSTRACT

The present disclosure provides for a water reacting hydrogen generating alloy composition, and associate methods for manufacturing such alloy compositions. In one implementation, the alloy composition provides hydrogen generation rates that are particularly customizable and adjustable for multiple intended uses and time-spans. In exemplary implementations, the alloy composition may be used for fuel cells or internal combustion engines.

### RELATED APPLICATIONS

This application claims the benefit of and priority to U.S. Provisional Application Ser. No. 60/625,018, filed on Nov. 3^{rd}, 2004, the contents of which are incorporated by reference herein in its entirety.

### BACKGROUND

1. Field

A composition, manufacturing method and uses are disclosed, which generally relate to hydrogen generation from an aqueous medium.

2. General Background

Hydrogen production and uses as a potential fuel have been areas of intense research in recent years. Hydrogen is particularly attractive as a fuel because of the lack of resultant production of polluting substances such as sulfur oxides and nitrogen oxides that are typically associated with the combustion of various petroleum based/derived fuels.

Various methods for producing hydrogen are known including various reactions that provide for electrolysis of water. As a further method of producing hydrogen, the reaction between magnesium and water is known. This reaction is illustrated by the following chemical equation
Mg+H₂O→Mg(OH)₂+H₂.

However, once magnesium hydroxide is formed on the surface of the magnesium, the magnesium hydroxide prevents further contact of magnesium with the surrounding water, so that the reaction is stopped and therefore the generation of hydrogen slows down or stops altogether.

### SUMMARY

The present disclosure provides for the use and formation of an alloy composition that provides for an efficient, clean, and controllable method of obtaining hydrogen upon exposure of the alloy composition to water. It is noted that the term alloy composition comprises both compositions of purely metallic elements and compositions which comprise both metallic and non-metallic elements. Thus, the term alloy composition should not be limited to compositions comprising only metallic elements.

In one aspect of the disclosure, a particularly useful composition of components is disclosed which provides an alloy composition mass and/or powder that can be formed and shaped in accordance with particular applications.

In one aspect of the disclosure, a method for forming a water-reactive hydrogen-producing alloy composition is disclosed that can be executed in a particular manner to obtain a hydrogen-producing alloy composition that generates hydrogen from water at particular rates.

In particular implementations, the hydrogen-producing alloy composition produces hydrogen upon exposure to an aqueous media. In one implementation, this hydrogen-producing alloy composition comprises magnesium, zinc, an organic acid, salt, water, and optionally, iron. In some implementations, the organic acid is citric acid. In other implementations, magnesium is present in about 38% to 48% by weight, the zinc is present in about 38% to 58% by weight, organic acid is present in about 12% to 20% by weight, salt is present in about 3% to 5% by weight, the water is present in about 3% to 5% by weight and said iron, if present, is present in about 3% to 5% by weight.

In some implementations, the salt utilized is sea salt. In some implementations, one or any combination of potassium chloride, sodium chloride, calcium chloride, magnesium chloride and magnesium bromide is utilized.

In one implementation, the hydrogen-producing alloy composition is in the form of a tablet. In one implementation, the shape or form of the hydrogen-producing alloy composition is formed by a mold. In particular implementations, the tablet is spherical or multifaceted. In other implementations, the alloy is formed into a star or square or lozenge or sphere or triangle or polygon or a cube or rectangle or rod or any desired shape.

In one implementation, a method for forming an alloy composition for hydrogen generation upon exposure of said composition to water comprises providing an amount of magnesium, zinc, salt, and an organic acid; combining the magnesium, zinc, salt, and organic acid to obtain a dry mix; and adding water and to the dry mix and mixing the dry mix with a predetermined amount of water to form a wet mix. In one implementation, this wet mix is compressed under a predetermined amount of pressure to form an alloy composition. In some implementations, the alloys may be pressed into a predetermined shape at this step. In other implementations, the alloy composition may be shaped into a final shape that is chosen in accordance with an end use of the alloy composition.

Various amounts of predetermined pressure can be utilized, from about 2000 lbs/square inch to about 20,000 lbs/square inch. Some implementations utilize pressure ranging from about 4000 lbs/square inch to about 8000 lbs/square inch.

In one implementation, a method for producing hydrogen is also provided, comprising providing an alloy composition, wherein the alloy composition comprises magnesium, zinc, an organic acid, salt, water and optionally, iron. In one implementation, the alloy composition is introduced into an amount aqueous medium, wherein hydrogen is produced via an interaction between the aqueous medium and the alloy composition. In one implementation, the alloy composition is in the form of a tablet.

In an exemplary implementation, the present disclosure provides an alloy composition that facilitates the generation of hydrogen from aqueous media, the composition of the alloy composition comprises about 60 grams of zinc, about 30 grams of magnesium, about 25 grams of citric acid, about 3 grams of sea salt and about 3 grams of water. In one implementation, a method for producing hydrogen, in this implementation comprises obtaining an alloy composition comprising about 60 grams of zinc, about 30 grams of magnesium, about 25 grams of citric acid, about 3 grams of sea salt and about 3 grams of water and then placing the alloy composition into a volume of water, whereupon hydrogen generation takes place and hydrogen is liberated from the water.

In particular implementations, a volume of water is about 9 times the volume of the alloy composition.

In some implementations, sugar can be a component of the alloy composition.

### BRIEF DESCRIPTION OF THE DRAWINGS

The foregoing aspects and advantages of this invention will become more readily apparent and understood with reference to the following detailed description, when taken in conjunction with the accompanying drawings, wherein:

FIG. 1 is a block flow diagram illustrating an exemplary method of producing the alloy composition.

FIG. 2 is a block flow diagram illustrating an exemplary method of producing hydrogen from the alloy composition.

### DETAILED DESCRIPTION

In one implementation of the present disclosure, various components are combined together in order to form an alloy composition that, when exposed to water, generates hydrogen. In some implementations, hydrogen is generated via the decomposition of water at a particular rate and manner. Exemplary components of the alloy composition comprise magnesium, zinc, citric acid, salt, and water. In one implementation, the alloy composition further comprises Iron. In another implementation, the alloy composition further comprises sugar. These components are provided to form useful alloy compositions that generate hydrogen in accordance with the teachings provided herein.

It is contemplated that the components comprising the hydrogen-producing alloy composition may have various forms, different percentages by weight, various purities, and many combinations thereof.

In one implementation, the components of the hydrogen-producing alloy composition, such as magnesium, zinc, citric acid, salt, and iron, may be provided in various forms. Powdered form, pellets, and other configurations (plates, rods, spheres, etc.) are contemplated to be useful, in accordance with the teachings provided herein. One exemplary implementation of various component forms is provided below:

| Component | Size |
|---|---|
| Magnesium (Mg) | 20 mesh to 40 mesh |
| Zinc(Zn) | 20 mesh to 40 mesh |
| Citric Acid | 8 mesh to 20 mesh |
| Salt | 20 mesh to 40 mesh |
| Iron (Fe) | 8 mesh to 12 mesh |

As depicted in the table above, exemplary mesh sizes (U.S. Series) for the various components are provided above. In this implementation, magnesium is provided in 20 to 40 mesh powder form, zinc in 20 to 40 mesh powder form, citric acid in 8 mesh to 20 mesh powder form, salt in 20 mesh to 40 mesh power form, and iron in 8 mesh to 12 mesh powder form. Various components having other mesh sizes are also contemplated as being useful and are within the scope of the present disclosure.

In another implementation, the inclusion of various salts into the alloy composition is contemplated. In various implementations, one or any combination of potassium chloride, sodium chloride, calcium chloride, magnesium chloride and magnesium bromide can be utilized.

In particular implementations, water that can be utilized in accordance with the teachings of the present disclosure comprises, but is not limited to, tap water (i.e. municipal water), distilled water, river water, lake water, ocean/sea water, natural spring water, well water and rain water, among others.

In a particular implementation, the various components are provided and mixed together to form alloy composition(s) at particular ratios that displays various hydrogen producing characteristics with a desired speed and longevity once placed into water. In one implementation, a fast reaction having a short-life span produces hydrogen from water for about 30 minutes. A slow reaction will liberate hydrogen from water at a much slower rate and which can run for about 7 days.

In one exemplary implementation, the ratios of each component of the alloy composition is depicted below.

| Component | Weight Percentage |
|---|---|
| Magnesium | about 38% to 48% |
| Zinc | about 38% to 58% |
| Citric Acid | about 12% to 20% |
| Salt | about 3% to 5% |
| Water | about 3% to 5% |
| If used: Iron | about 3% to 5% |

As depicted in the table above, each component of the alloy composition is associated with a particular ratio. In this exemplary implementation, magnesium has a ratio by weight of about 38 to 48%, zinc has a ratio by weight of about 38 to 58%, citric acid has a ratio by weight of about 12 to 20%, salt has a ratio by weight of about 3 to 5%, water has a ratio of about 3 to about 5%, and iron has a ratio of about 3 to 5%. Of course, it is contemplated that the alloy composition can comprise components each having any number by ratio of weight.

In another implementation, the purity of each component comprising the alloy composition may be varied. In one implementation, for hydrogen generated for particular uses (for example, in a fuel cell or an internal combustion engine {ICE}) it has been found that particular purities of various metallic components, such as the magnesium, zinc, and iron, provide optimal hydrogen generation characteristics. In an exemplary implementation, an exemplary partial list of components and their respective percentage of purity is provided below.

| Material | Purity (ICE) |
|---|---|
| Magnesium (Mg) | ˜85% |
| Zinc (Zn) | ˜80% |
| Iron (Fe) | ˜80% |

As depicted in the table above, in one implementation, in the application of an internal combustion engine (ICE) the components of an alloy composition have a particular purity. Specifically, magnesium has about 85% purity, zinc has about 80% purity, and iron has about 80% purity.

Of course, the percentage of purity may be varied according to the desired application of the alloy composition. Another exemplary implementation of the associated purities for a partial list of components of an alloy composition for a fuel cell application is depicted in the table below.

| Material | Purity (fuel cell) |
|---|---|
| Magnesium (Mg) | ˜96% |
| Zinc (Zn) | ˜96% |
| Iron (Fe) | ˜90% |
| Water | Tap Water |

As depicted in the table above, in one implementation, in the application of a fuel cell the components of an alloy composition have a particular purity. Specifically, magnesium has about 96% purity, zinc has about 96% purity, iron has about 90% purity, and water may be tap water.

In one implementation, regardless of its components an acid-reactive hydrogen producing alloy composition can be provided in any desired shape. In one implementation, an exemplary shape comprises a tablet, having a spherical or multifaceted shape, although any desired shape may be utilized in accordance with an end use of the alloy composition. In one implementation, the overall dimensions of the alloy composition(s) is in accordance with internal volumes/spaces of a reaction vessel that will contain aqueous fluids and hydrogen producing alloy composition(s). While the term “tablet” is utilized, it is to be taken as a generic term, and the alloy compositions need not be a “tablet” shape. For example, the alloy composition can be formed into a star shape or square or lozenge or sphere or triangle or polygon or a cube or rectangular or rod or any shape so desired.

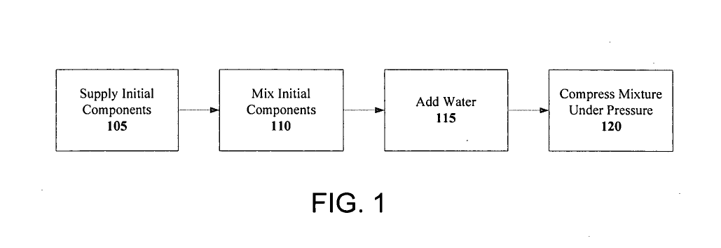

Various methods of creating the hydrogen-producing alloy composition are disclosed herein. One exemplary method of manufacturing the alloy composition is depicted in FIG. 1.

As depicted in FIG. 1, first, the components of the alloy composition are supplied 105. The components may include any of the implementations in any of their purities, percentages, and forms disclosed herein and any combinations thereof. Then, in one implementation, the components combined 110 by weight and hand stirred. This results in a dry mix. Water is then added 115 and mixed in, creating a wet mix. As stated above, the ratios of various components change the rate at which hydrogen is produced from water and longevity of the tablet. The components all play a role in adjusting the rate and longevity of the components.

In particular implementations, the higher the zinc content and citric acid content in the alloy composition, the faster the reaction. Additionally, a lower/slower hydrogen generating reaction (H₂ produced/time) is observed upon increasing magnesium content in the alloy composition.

In an exemplary implementation, the higher the salt content, the faster the various alloy composition components dissolve in water. The salt content of the alloy composition is utilized to help maintain the reaction between the metallic content of the alloy composition and the water. As oxides form on the surface of the alloy composition, the oxide buildup hinders further reactions between non-oxidized metals in the alloy compositions and the surrounding aqueous medium (e.g. water). However, salt in the alloy composition provides for an etching effect on the surface of the alloy composition. As the salt in the alloy composition dissolves over time, the salt is removed from the surface of the alloy composition, this action serving to also remove oxides formed on the surface of the alloy composition. This salt-dissolving process which removes salt at the surface of the alloy composition exposes fresh (i.e. non-oxidized) alloy composition components to the water such that the hydrogen producing reaction can proceed.

In other implementations, the water content of the alloy composition is varied. It has been observed that the higher the water content and the higher the heat utilized during formation/compression of the components to form the alloy composition, the harder the finished alloy composition is upon completion of processing. The hardness will increase and thus the life-span of a hydrogen-producing reaction between the alloy composition will lengthen.

Turning back to FIG. 1, subsequent to creating a wet mix 115, the wet mix is then compressed 120 under pressure, to form an alloy composition tablet, having a particular shape, depending on the tablet's end use. In particular implementations, control of a hydrogen generating reaction may also be obtained through the particular shape that the alloy composition takes. For example, spherical shapes of alloy composition may produce a relatively slow reaction as compared to an alloy composition of the same mass having a shape such that its surface area is increased, such as a star or cube, for example. Exemplary shapes can be, but are not limited to, a square, a lozenge shape or any multifaceted shape or any shape that provides a desired surface area. By increasing surface area of the alloy composition exposed to water, the faster the hydrogen generating reaction proceeds.

In one implementation, the amount of pressure used to compress the alloy composition is inversely related to the rate of hydrogen generation. Thus, the higher the pressure, the slower the hydrogen generation reaction and the longer the time is takes to dissolve the tablet once placed into water. Hydrogen output is observed at a higher rate than the Btu rate of the components exposed to water without compression. Exemplary compression ranges may be between about 2000 lbs to about 20000 lbs of pressure per square inch. In some implementations, the pressure range may be between about 2000 lbs to about 5000 lbs of pressure per square inch. In other implementations, the pressure range is preferably between about 3500 lbs to about 4000 lbs of pressure per square inch. In other implementations, about 4000 lbs of pressure per square inch are utilized to form the alloy composition tablet.

In one exemplary implementation of a method of creating a hydrogen-producing alloy composition, the alloy composition comprises about 60 grams of zinc, about 30 grams of magnesium, about 25 grams of citric acid and about 3 grams of sea salt. Then, the components are combined with about 3 grams of water. After mixing the components and water, a wet mix formed. Then, the resultant wet mix is compressed at about 8,000 lbs/per square inch. The alloy composition can be formed into any desired shape. In one example, rods having ¾ inch diameter are provided and then dropped into water, the amount of water being 9 times the volume of the compressed and formed alloy composition. In some implementations, sugar is included as a component. Exemplary amounts in this implementation is from about 1.5 to 3 grams of sugar, which heats and form a bond with the components while in the forming mode.

In particular implementations, sugar is a useful component when utilizing compression forces in the about 2,000 to about 8,000 lbs/per square inch range.

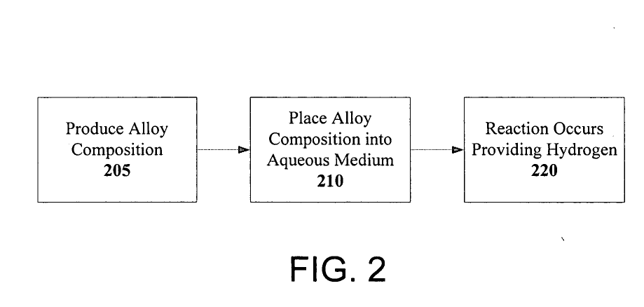

FIG. 2 depicts a flow diagram for the generation of hydrogen of one implementation. First, the alloy composition is produced 205 using any of the methods as described herein. For example, the hydrogen-producing alloy composition may be produced according to the method depicted in FIG. 1. Of course, the hydrogen-producing alloy may be produced according to various other methods disclosed herein and obvious modifications thereof. The alloy is then placed into a aqueous medium 210. Finally, the aqueous medium and the alloy come into contact 215, reacting to form hydrogen.

In one implementation, the alloy composition is submersed in a volume of water, typically in a multiple of the volume of the alloy composition. Exemplary multiples range from about 2 to about 20 volumes of water to 1 volume of formed alloy composition, from about 2 to about 10 volumes of water to 1 volume of formed alloy composition and from about 6 volumes of water to 1 volume of formed alloy composition. In one implementation, the alloy composition changes the pH levels of the water into which the alloy composition is placed, changing the water from a neutral pH to alkaline as hydrogen is liberated from the water. In one implementation, the citric acid component of the alloy composition helps to neutralize the rising pH of the water through an acid-base reaction, resulting in the formation of more water and a resultant salt.

In one implementation, the amount of scum that forms will be reduced as a result of placement of the alloy (or alloy composition) into water. This lack of scum formation is desirable, as scum formation and resultant slowing and/or stoppage of hydrogen production has been an issue in various prior art methods that utilize various metals/alloy for water electrolysis and hydrogen generation. In one implementation, the compression of the components elongates the hydrogen reaction without the use of dangerous acids or polluting waste streams. In one implementation, the alloy composition is able to withstand reacting acids and holds its shape to create a longer lasting reaction. In further implementations, Iron may be used to reduce any formation of scum and assist in the cracking process in hydrogen creation by absorbing oxides that form as a result of the hydrogen generating reactions proceeding as a result of the exposure of the magnesium and zinc to water.

While the above description contains many particulars, these should not be consider limitations on the scope of the invention, but rather a demonstration of implementations thereof. The alloy composition, method for making and uses disclosed herein include any combination of the different species or implementations disclosed. Accordingly, it is not intended that the scope of the invention in any way be limited by the above description. The various elements of the claims and claims themselves may be combined any combination, in accordance with the teachings of the present disclosure, which includes the claims.

What is claimed is:

1.) An alloy composition for producing hydrogen upon exposure to an aqueous medium, comprising:
magnesium, zinc, an organic acid, salt, water

2.) The composition of claim 1 further comprising iron.

3.) The composition of claim 1, wherein said organic acid comprises citric acid.

4.) The composition of claim 1, wherein said magnesium is present in about 38% to 48% by weight, the zinc is present in about 38% to 58% by weight, the organic acid is present in about 12% to 20% by weight, the salt is present in about 3% to 5% by weight, the water is present in about 3% to 5% by weight.

5.) The composition of claim 1 further comprising iron present in about 3% to 5% by weight.

6.) The composition of claim 1, wherein said salt comprises sea salt.

7.) The composition of claim 1, wherein said composition is spherically shaped.

8.) The composition of claim 1, wherein said composition is multifaceted.

9.) The composition of claim 1, wherein the said aqueous medium comprises water.

10.) The composition of claim 1 further comprising sugar.

11.) A method for forming an alloy composition for hydrogen generation upon exposure of said alloy composition to water, comprising:
providing an amount of magnesium, zinc, salt and an organic acid;
combining said magnesium, zinc, salt and organic acid to form a dry mix;
mixing said dry mix with a predetermined amount of water to form a wet mix;
compressing said wet mix under a predetermined amount of pressure to form said alloy composition.

12.) The method of claim 11, wherein said magnesium is present in about 38% to 48% by weight, the zinc is present in about 38% to 58% by weight, the organic acid is present in about 12% to 20% by weight, the salt is present in about 3% to 5% by weight, the water is present in about 3% to 5% by weight.

13.) The method of claim 11, wherein said dry mix further comprises iron in an amount of about 3% to 5% by weight.

14.) The method of claim 11, further comprises forming said alloy composition into a predetermined shape that is chosen in accordance with an end use of said alloy composition.

15.) The method of claim 11, wherein said predetermined amount of pressure is from about 2000 lbs/square inch to about 20000 lbs/square inch.

16.) The method of claim 11, wherein said predetermined amount of pressure is from about 2000 lbs/square inch to about 5000 lbs/square inch.

17.) The method of claim 11, wherein said predetermined amount of pressure is from about 4000 lbs/square inch.

18.) A method for producing hydrogen, comprising:
providing an alloy composition, wherein said composition comprises magnesium, zinc, an organic acid, salt, water;
introducing said composition into an amount of an aqueous medium; and
producing an amount of hydrogen via an interaction between said aqueous medium and said alloy composition.

19.) The method of claim 18, wherein the alloy composition further comprises iron.

20.) The method of claim 18, wherein said magnesium is present in about 38% to 48% by weight, the zinc is present in about 38% to 58% by weight, the organic acid is present in about 12% to 20% by weight, the salt is present in about 3% to 5% by weight, the water is present in about 3% to 5% by weight.

21.) The method of claim 18, wherein the iron is present in about 3% to 5% by weight.

22.) The method of claim 18, wherein said alloy composition has a predetermined shape that is in accordance with an end use of said alloy composition.

23.) The method of claim 18, wherein said organic acid comprises citric acid.

24.) The method of claim 18, wherein said salt comprises sea salt.

25.) The method of claim 18, wherein said sea salt is selected from the group consisting of potassium chloride, sodium chloride, calcium chloride, magnesium chloride and magnesium bromide.

26.) An alloy composition that facilitates the generation of hydrogen from aqueous media, comprising:
about 60 grams of zinc;
about 30 grams of magnesium;
about 25 grams of citric acid;
about 3 grams of sea salt; and
about 3 grams of water.

27.) A method for producing hydrogen, comprising:
obtaining an alloy composition comprising about 60 grams of zinc, about 30 grams of magnesium, about 25 grams of citric acid, about 3 grams of sea salt and about 3 grams of water; and
allowing said alloy composition to come into contact with a volume of water, where after said contact, hydrogen generation takes place and hydrogen is liberated from said water.

28.) The method according to claim 27, wherein said volume of water is about 9 times the volume of said alloy composition.

29.) The method according to claim 27, wherein components of said alloy composition are formed and compressed under about 8000 lbs of pressure per square inch.

30.) The method of claim 27 further comprising about 1.5 to 3 grams of sugar.
